(19) United States
(12) Patent Application Publication
(10) Pub. No.: US 2026/0065089 A1
(43) Pub. Date: Mar. 5, 2026

(54) Systems and methods for providing a resolution recommendation service

(71) Applicant: Virtusa Corporation, Southborough, MA (US)

(72) Inventors: Inderjeet Singh Aidhi, Hyderabad (IN); Khamarutheen Kottur Abdurlazak, Chennai (IN); Lourdu Jerald B, Chennai (IN)

(21) Appl. No.: 19/307,836

(22) Filed: Aug. 22, 2025

(30) Foreign Application Priority Data
Aug. 28, 2024 (IN) 202411064821

(51) Int. Cl. G06N 5/022

(52) U.S. Cl. CPC G06N 5/022

(57) ABSTRACT

Systems and methods for providing a resolution recommendation service. The method includes receiving at an interface a ticket; executing at least one of a plurality of processing procedures on the ticket, wherein the processing procedures include a text cleaning procedure, a text normalization procedure, or a text tokenization procedure; and processing the ticket using a pre-trained large language model to extract a context from the ticket, the context including one or more of an element, a relationship, or an intent. The method further includes analyzing one or more knowledge base articles using the model and the extracted context to generate a resolution recommendation and presenting to a user via a user interface the generated resolution recommendation.

### CROSS REFERENCE TO RELATED APPLICATIONS

The present application claims the benefit of and priority to Indian Provisional Application no. 202411064821, filed on Aug. 28, 2024, the entire content of which is hereby incorporated by reference as if set forth in its entirety herein.

### TECHNICAL FIELD

Embodiments described herein generally relate to systems and methods for processing tickets and, more specifically but not exclusively, to systems and methods for providing a resolution recommendation services.

### BACKGROUND

Addressing tickets such as incident reports generally relies on referencing existing knowledge bases. A knowledge base may refer to a data repository accessed to solve a problem identified in a ticket. For example, a user may provide a ticket which includes a problem statement, and a system or person may reference a knowledge base to identify a possible solution.

Existing knowledge base systems generally rely on keyword matching techniques to identify words within a ticket. These existing systems then recommend relevant knowledge base articles based on the matched keywords.

These techniques and systems have limitations. First, keyword-matching techniques do not capture the full context of a ticket. This may result in the identification of irrelevant, generic, or otherwise unhelpful solutions in a knowledge base. Second, existing systems often require administrators to manually update knowledge bases with new reports or documentation to reflect the latest available information. This can be time-consuming, resource-intensive, and prone to errors. Third, existing knowledge base systems lack the ability to learn and adapt to new situations. Similarly, they lack the ability to adapt to evolving language patterns with tickets or incident descriptions.

A need exists, therefore, for systems and methods that overcome the disadvantages of existing techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a method for providing a resolution recommendation service. The method includes receiving at an interface a ticket; executing at least one of a plurality of processing procedures on the ticket, wherein the processing procedures include a text cleaning procedure, a text normalization procedure, or a text tokenization procedure; processing the ticket using a pre-trained large language model to extract a context from the ticket, the context including one or more of an element, a relationship, or an intent; analyzing one or more knowledge base articles using the model and the extracted context to generate a resolution recommendation; and presenting to a user via a user interface the generated resolution recommendation.

In some embodiments, the ticket is received via email, a ticketing report, or a user portal.

In some embodiments, the method further includes receiving a user input regarding the generated resolution recommendation, and updating the pre-trained large language model based on the received user input.

In some embodiments, the method further includes retrieving one or more knowledge base articles from a data store using the extracted context.

In some embodiments, the method further includes vectorizing a received training ticket to transform the training ticket into at least one vector, and storing the vector in a vector database.

In some embodiments, analyzing the knowledge base articles includes supplying the articles and the extracted context to the model and receiving the resolution recommendation from the model.

According to another aspect, embodiments relate to a system for providing a resolution recommendation service. The system includes a data store storing a plurality of knowledge base articles; an interface for receiving a ticket; one or more processors executing instructions stored on memory and configured to: execute at least one of a plurality of processing procedures on the received ticket, wherein the processing procedures include a text cleaning procedure, a text normalization procedure, or a text tokenization procedure; process the ticket using a pre-trained large language model to extract a context from the ticket, the context including one or more of an element, a relationship, or an intent; analyze one or more knowledge base articles using the model and the extracted context to generate a resolution recommendation; and a user interface configured to present to a user the generated resolution recommendation.

In some embodiments, the ticket is received via email, ticketing reports, or a user portal.

In some embodiments, the user interface is further configured to receive a user feedback regarding the generated resolution recommendation, and the one or more processors are further configured to update the pre-trained large language model based on the received user feedback.

In some embodiments, the one or more processors are further configured to retrieve one or more knowledge base articles from a data store using the extracted context.

In some embodiments, the one or more processors are further configured to vectorize a received training ticket to transform the training ticket into at least one vector, and store the vector in a vector database.

In some embodiments, analyzing the knowledge base articles includes supplying the articles and the extracted context to the model and receiving the recommendation from the model.

According to yet another aspect, embodiments relate to a computer program product for providing a resolution recommendation service. The computer program product comprises computer executable code embodied in one or more non-transitory computer readable media that, when executing on one or more processors, performs the steps of receiving at an interface a ticket; executing at least one of a plurality of processing procedures on the ticket, wherein the processing procedures include a text cleaning procedure, a text normalization procedure, or a text tokenization procedure; processing the ticket using a pre-trained large language model to extract a context from the ticket, the context including one or more of an element, a relationship, or an intent; analyzing one or more knowledge base articles using the model and the extracted context to generate a resolution recommendation; and presenting to a user via a user interface the generated resolution recommendation.

In some embodiments, the ticket is received via email, a ticketing report, or a user portal.

In some embodiments, the computer program product further comprises computer executable code that, when executing on one or more processors, performs the steps of receiving a user feedback via the user interface regarding the generated resolution recommendation, and updating the pre-trained large language model based on the received user feedback.

In some embodiments, the computer program product further comprises computer executable code that, when executing on one or more processors, performs the steps of vectorizing a received training ticket to transform the training ticket into at least one vector, and storing the vector in a vector database.

In some embodiments, analyzing the knowledge base articles includes supplying the articles and the extracted context to the model and receiving the resolution recommendation from the model.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a system for providing a resolution recommendation service in accordance with one embodiment;

FIG. 2 illustrates the pre-processing module of FIG. 1 in accordance with one embodiment; and

FIG. 3 depicts a flowchart of a method for providing a resolution recommendation service in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including standard hard drives, solid state storage, floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

A computer system (standalone, client or server computer system) configured by an application may constitute a “subsystem” that is configured and operated to perform certain operations. In one embodiment, the “subsystem” may be implemented mechanically or electronically, so a subsystem may comprise dedicated circuitry or logic that is permanently configured (within a special-purpose processor) to perform certain operations. In another embodiment, a “subsystem” may also comprise programmable logic or circuitry (as encompassed within a general-purpose processor or other programmable processor) that is temporarily configured by software to perform certain operations.

Accordingly, the term “subsystem” should be understood to encompass a tangible entity, be that an entity that is physically constructed permanently configured (hardwired) or temporarily configured (programmed) to operate in a certain manner and/or to perform certain operations described herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Reference will now be made in detail to the exemplary embodiments, examples of which are illustrated in the accompanying drawings. Wherever possible, the same reference numbers will be used throughout the drawings to refer to the same or like parts.

Embodiments described herein provide novel techniques for providing a resolution recommendation service. The described embodiments overcome the disadvantages of existing techniques by using pre-trained large language models in the incident resolution process. The described embodiments can analyze an entire incident problem description of a ticket such as a ticket to capture nuanced details and interrelationships between different elements therein. This comprehensive understanding enables the embodiments herein to provide highly accurate and tailored resolution recommendations as compared to existing keyword-based approaches.

The present application largely discusses generating resolution recommendations in the information technology (“IT”) operations environment. However, the features of the described embodiments may be implemented in a variety of other industries or applications.

As one example, the features of the described embodiments may analyze customer service inquiries in any sort of field or application. Customers may submit tickets through a customer portal, through email, or the like. The embodiments herein may analyze the reports to identify context associated therewith. The embodiments herein may then recommend appropriate solutions for the customer based on the context associated with the customer's issue(s) described in the tickets and one or more pre-trained large language models.

As another example, the described embodiments may analyze technical reports such as those in construction, military, or manufacturing applications. For example, the embodiments herein may recommend troubleshooting steps tailored to a specific type of component, machine, equipment, system, or the like.

As another example, the described embodiments may be implemented in telecommunications-based applications. For example, the disclosed embodiments can process network tickets and internal documentation to improve service uptime in tasks associated with providing resolution recommendations.

The features of the described embodiments may also integrate with field service management systems to assist technicians on-site. These systems may provide recommendations regarding repairs or equipment troubleshooting steps based on reported issues and available data. For example, the embodiments herein may identify the context associated with the technician such as the customer's type of equipment, location, equipment history, customer history, weather, or the like.

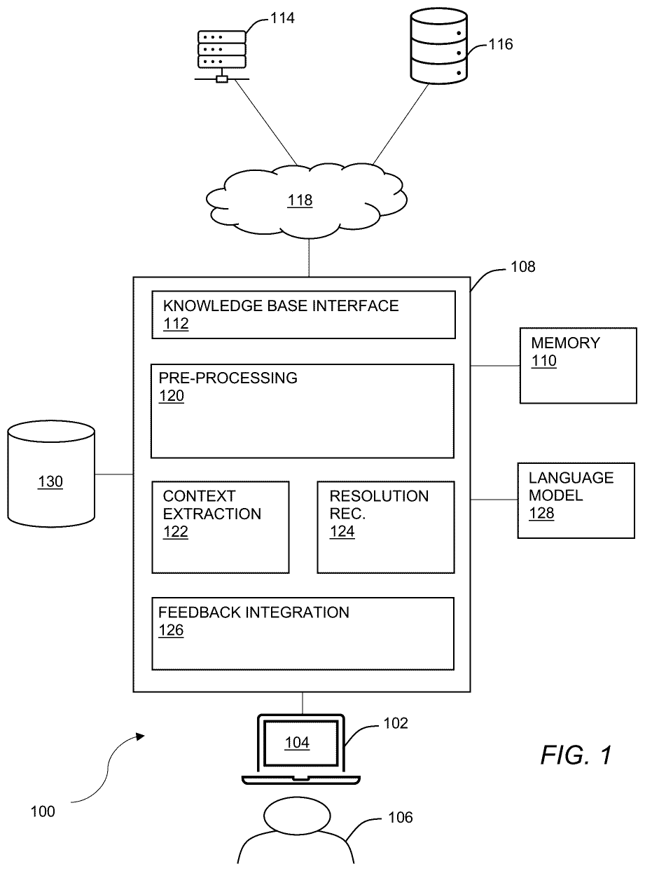

FIG. 1 illustrates a system 100 for providing a resolution recommendation service in accordance with one embodiment. The system 100 may include a user device 102 executing a user interface 104 accessible by a user 106. The user device 102 may include an input/output (I/O) device such as, but not limited to, a laptop, PC, tablet, smartphone, smartwatch, or any other type of device that can execute the user interface 104 to allow the user 106 to provide requests, tickets such as incident reports, review resolution recommendations, provide feedback regarding resolution recommendations, or some combination thereof.

The user interface 104 may implement or otherwise rely on the Streamlit Python library and framework. In some embodiments, the user interface 104 may allow the user 106 to submit requests for resolutions. For example, the user interface 104 may allow the user 106 to submit a ticket, and the system 100 may interpret the receipt of the ticket as a request for a resolution to a problem presented or otherwise described therein. The user 106 may provide the ticket via one of a variety of techniques such as email, a ticketing report, or a through user portal.

The user device 102 may be in operable connectivity with one or more processors 108 executing instructions stored in memory 110. The processor(s) 108 may be any hardware device capable of executing instructions stored on memory 110 to provide various components or modules. The processor 108 may include a microprocessor, a field programmable gate array (FPGA), an application-specific integrated circuit (ASIC), or other similar devices.

In some embodiments, such as those relying on one or more ASICs, the functionality described as being provided in part via software may instead be configured into the design of the ASICs and, as such, the associated software may be omitted. The processor 108 may be configured as part of the user device 102 (e.g., a laptop) or located at some remote location.

The memory 110 may be L1, L2, L3 cache, or RAM memory configurations. The memory 110 may include non-volatile memory such as flash memory, EPROM, EEPROM, ROM, and PROM, or volatile memory such as static or dynamic RAM, as discussed above. The exact configuration or type of memory 110 may vary as long as instructions for providing a resolution recommendation service can be performed by the system 100.

The system 100 may include a knowledge base interface 112 to receive knowledge base articles from a knowledge base. The knowledge base may comprise data stores or content sources such as an IT Service Management (“ITSM”) Tool 114 storing archived tickets, and an internal content source 116 accessible over one or more networks 118. The processor 108 may also execute a pre-processing module 120, a context extraction module 122, a resolution recommendation engine 124, and a feedback integration module 126.

The ITSM tool 114 may store archived tickets relating to previous tickets and their resolution(s). The internal content source 116 may refer to a database of internal documents such as emails, internal chat-based messages, data from user portals, or the like. These content items may include internal documents such as Excel files, Word files, Sharepoint data, Wiki pages, etc.

These stored documents and content items, collectively referred to as “knowledge base articles,” may relate to or include documentation regarding resolved incidents or uploads of other document sources. In addition to or in lieu of these content sources 114 and 116, a user may manually provide knowledge base articles.

In some embodiments, the content sources 114 and 116 may retrieve tickets or other types of documentation from data sources at predetermined intervals such as hourly, at the end of each day, at the end of each week, or the like. Accordingly, the knowledge base may be continuously expanded and improved based on the receipt of new articles.

The network(s) 118 may link the various components with various types of network connections. The network(s) 118 may be comprised of, or may interface to, any one or more of the Internet, an intranet, a Personal Area Network (PAN), a Local Area Network (LAN), a Wide Arca Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network or networks 118 may also comprise, include, or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link, or a Time Division Multiple access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based link.

The processor(s) 108 may also be in communication with one or more pre-trained large language models 128 and one or more databases 130. The databases 130 may store vectorized tickets. In some embodiments, the database 130 may be a Chroma vector database made available by Chroma, headquartered in San Francisco, California.

In operation, the user 106 may provide some input with respect to the user interface 104 to make a request for a resolution recommendation. For example, the user 106 may be an administrator associated with a corporate entity and tasked with aiding a customer in addressing some problem specified in an incident report. Similarly, the user 106 may be a customer interested in submitting an incident report to receive a resolution recommendation.

Each submitted ticket may be associated with a problem description. For example, a particular ticket may be a request from an employee for assistance regarding a problem they are having with their computer. In this situation the identified problem description may refer to the employee's problem (e.g., their computer routinely freezes) with accompanying data such as how long the problem has occurred, how often the problem occurs, the type of computer the employee is using, etc. In some embodiments, a ticket may have a “problem description” field, the value for which is the problem.

The knowledge base interface 112 may be implemented via the FastAPI Python web framework. The knowledge base interface 112 may refer to a representational state transfer (RESTful) interface that can use Hypertext Transfer Protocol (HTTP) functions such GET, POST, or DELETE to intake or process data from the knowledge base of content sources 114 and 116.

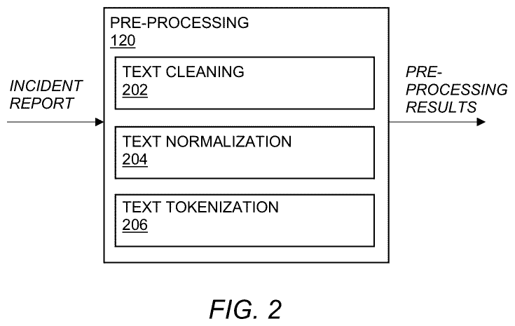

The pre-processing module 120 may execute one or more of a plurality of processing procedures on a received ticket. FIG. 2 illustrates the pre-processing module 120 of FIG. 1 in accordance with one embodiment. The pre-processing module 120 may include a text cleaning submodule 202, a text normalization submodule 204, and a text tokenization submodule 206.

The text cleaning submodule 202 may perform various text cleaning procedures on the text within a ticket. For example, the text cleaning submodule 202 may take steps to remove contractions, remove emojis, remove extra spaces, remove punctuation, etc.

The text normalization submodule 204 may perform one or more procedures to transform the text of tickets into a consistent format or structure. For example, the text normalization submodule 204 may include normalizing the case of text to make data consistent and reduce the dimensionality of data, removing stop words, stemming, lemmatization, or the like.

The text tokenization submodule 206 may perform one or more procedures for tokenizing the tickets. Tokenization may refer to the process of breaking the text into individual tokens, which may comprise individual phrases, words, sub-words, or characters.

These pre-processing procedures and associated submodules are only exemplary, and other pre-processing procedures whether available now or invented hereafter may be implemented. For example, other language processing techniques may include, but are not limited to, named entity recognition (NER), stemming and lemmatization, stop words removal, part-of-speech tagging, Term Frequency-Inverse Document Frequency (TF-IDF), etc.

The pre-processing results may then be vectorized and stored in the database(s) 130. These vectorized results may subsequently be communicated to the context extraction module 122. The context extraction module 122 may rely on the pre-trained large language model(s) 128 to execute natural language processing techniques on the pre-processed content items to determine the meaning of the content item(s). Accordingly, the context extraction module 122 may obtain a deeper level of understanding of the content items by identifying a context including at least one of an element, a relationship, or an intent of the items in a ticket. For example, the context extraction module 122 may determine the meaning of the extracted tokens from the pre-processing module 120.

In the context of the present application, the term “meaning” as applied to content items may refer to the definition of individual words included in the content items, as well as the overall intention of a word or group of words. For example, the meaning of a string of words may include an identification of the words as presenting a question, as well as the actual desired information from the question.

In some embodiments, the context extraction module 122 may determine a title or one or topic identifiers associated with the ticket. The resolution recommendation engine 124 and the pre-trained large language model 128 may then know which knowledge base article(s) of the content sources 114 and 116 to search and analyze to generate a resolution recommendation.

By understanding ticket context, the embodiments herein can identify the most relevant knowledge base articles from the content sources 114 and 116, reduce the time required for searching for information, and avoid suggesting inaccurate resolution recommendations. In other words, the tailored resolution recommendations increase the likelihood of resolving an issue on the first attempt. This not only saves time and preserves computational resources, but minimizes customer frustration as the customer is more likely to receive an accurate resolution recommendation on the first attempt.

Accordingly, based on the extracted context, the resolution recommendation engine 124 can leverage the pre-trained large language model(s) 128 to analyze existing knowledge base articles and recommend resolution steps tailored to a specific problem description. A resolution recommendation may refer to one or more actions to be taken to address a problem. For example, a knowledge base article may include data indicative of steps taken to address a certain type of problem. These steps may have initially been suggested by an administrator or otherwise someone tasked with helping employees address certain types of problems. Additionally or alternatively, the resolution steps may be based on data combined from multiple knowledge base articles.

For example, if a ticket indicates a problem is that a user's computer is slow, a resolution recommendation may be for the employee to “upgrade software,” or “restart computer.” A knowledge base article may indicate which actions or troubleshooting steps have been successful in addressing a problem. This data may be the result of feedback provided by others in response to previously-issued resolution recommendations. In some embodiments, only one of several troubleshooting steps may have been successful in addressing a problem. Accordingly, in these instances, a resolution may refer to the troubleshooting step that was most successful in addressing a problem. In some embodiments, the resolution recommendations may include a ranked list of recommendations.

The user interface 104 may then present to the user 106 the resolution recommendation. The resolution recommendation may also include details supporting the resolution recommendation, such as the knowledge base articles referenced in generating the recommendation.

The feedback integration module 126 may allow the user 106 to provide some form of feedback regarding the recommended resolution. The user 106 may indicate whether the resolution recommendation is relevant (e.g., whether it is related to the type of equipment used by the user 106), whether it addressed the problem presented in the ticket, whether the resolution recommendation was easy to understand, etc.

This feedback may be binary feedback, such as whether the user 106 believes the resolution recommendation is helpful or unhelpful. Additionally or alternatively, the feedback may include modifications to the resolution recommendation, suggestions regarding how the recommended resolution may be more helpful, or why it was incorrect. The system 100 may then update the applicable knowledge base articles, pre-trained large language model(s) 128, or both, so that the system 100 incorporates the feedback in generating future resolution recommendations.

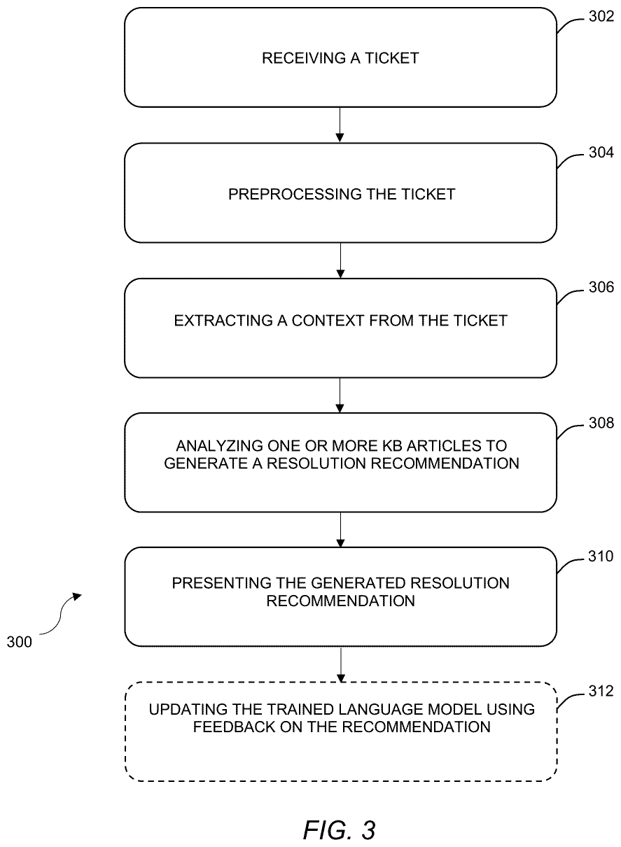

FIG. 3 depicts a flowchart of a method 300 for providing a resolution recommendation service in accordance with one embodiment. The system 100 of FIG. 1 or the components thereof may perform one or more of the steps of FIG. 3.

Step 302 involves receiving at an interface a ticket. For example, a user such as the user 106 may provide a ticket in which they describe a problem for which they would like a resolution. In the context of the present application, a ticket may comprise an incident description, service request, a task assignment, a change request, etc.

Step 304 involves executing at least one of a plurality of pre-processing procedures on the ticket. The pre-processing module 120 of FIGS. 1 and 2 may perform step 304. These procedures may include a text cleaning procedure, a text normalization procedure, a text tokenization procedure, or some combination thereof. The results of these pre-processing procedures may be vectorized and stored in a database such as the database 130 of FIG. 1.

Step 306 involves processing the ticket using a pre-trained large language model to extract a context from the ticket. The context may refer to one or more of an element, a relationship, or an intent. In the context of the present application, “element” may refer to one or more characters or words in a ticket. These elements may be represented as tokens or vectors, for example.

Step 308 involves analyzing one or more knowledge base articles using the model and the extracted context to generate a resolution recommendation. The extracted context may indicate the meaning of words in the ticket, their relationships, and other data that may be helpful in identifying the topic of the ticket, the problem description, parameters associated with the problem, or the like. Accordingly, the embodiments herein may more accurately identify relevant knowledge base articles for analysis in generating resolution recommendations.

Step 310 involves presenting to a user via a user interface the generated resolution recommendation. The generated resolution recommendation may be in natural language and include supporting evidence regarding why the resolution recommendation was generated.

Step 312 is optional and involves receiving a user feedback regarding the generated resolution recommendation, and updating the pre-trained large language model based on the received user feedback. The embodiments herein may use this feedback to refine the large language model 128 and improve recommendation accuracy over time.

The described embodiments provide numerous advantages over existing techniques for processing tickets. First, the embodiments leverage trained models to understand the context associated with tickets. This enables the described embodiments to deliver significantly more accurate and relevant resolution recommendations compared to traditional keyword-based systems. This results in a higher first-time resolution rate and reduced troubleshooting time.

Second, the disclosed embodiments streamline the incident resolution process by automating the selection of relevant knowledge base articles. This reduces analyst workload and accelerates the overall resolution time.

Third, the combination of faster resolution times and increased efficiency leads to substantial cost savings by organizations. This is due to minimizing support ticket volumes and the labor costs associated with fielding tickets.

Fourth, the disclosed embodiments continuously learn and improve based on received feedback. Accordingly, the disclosed embodiments remain effective even with evolving incident types and knowledge base content.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. The systems and methods involving hardware and software and/or functional parts therefore may be physically integrated into or housed inside or attached to another device, be it an imaging device, a stimulus or electrophysiological recording device, and patient audio device, etc. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for providing a resolution recommendation service, the method comprising:
receiving at an interface a ticket;
executing at least one of a plurality of processing procedures on the ticket, wherein the processing procedures include a text cleaning procedure, a text normalization procedure, or a text tokenization procedure;
processing the ticket using a pre-trained large language model to extract a context from the ticket, the context including one or more of an element, a relationship, or an intent;
analyzing one or more knowledge base articles using the model and the extracted context to generate a resolution recommendation; and
presenting to a user via a user interface the generated resolution recommendation.

2. The method of claim 1, wherein the ticket is received via at least one of email, a ticketing report, or a user portal.

3. The method of claim 1, further comprising:
receiving a user feedback regarding the generated resolution recommendation, and
updating the pre-trained large language model based on the received user feedback.

4. The method of claim 1 further comprising retrieving one or more knowledge base articles from a data store using the extracted context.

5. The method of claim 1 further comprising vectorizing a received training ticket to transform the training ticket into at least one vector, and storing the vector in a vector database.

6. The method of claim 1 wherein analyzing the knowledge base articles includes supplying the articles and the extracted context to the model and receiving the resolution recommendation from the model.

7. A system for providing a resolution recommendation service, the system comprising:
a data store storing a plurality of knowledge base articles;
an interface for receiving a ticket; and
one or more processors executing instructions stored on memory and configured to:
execute at least one of a plurality of processing procedures on the received ticket, wherein the processing procedures include a text cleaning procedure, a text normalization procedure, or a text tokenization procedure,
process the ticket using a pre-trained large language model to extract a context from the ticket, the context including one or more of an element, a relationship, or an intent;
analyze one or more knowledge base articles using the model and the extracted context to generate a resolution recommendation; and
a user interface configured to present to a user the generated resolution recommendation.

8. The system of claim 7 wherein the ticket is received via at least one of email, ticketing reports, or a user portal.

9. The system of claim 7 wherein the user interface is further configured to receive a user feedback regarding the generated resolution recommendation, and the one or more processors are further configured to update the pre-trained large language model based on the received user feedback.

10. The system of claim 7 wherein the one or more processors are further configured to retrieve one or more knowledge base articles from the data store using the extracted context.

11. The system of claim 7 wherein the one or more processors are further configured to vectorize a received training ticket to transform the training ticket into at least one vector, and store the vector in a vector database.

12. The system of claim 7 wherein analyzing the knowledge base articles includes supplying the articles and the extracted context to the model and receiving the recommendation from the model.

13. A computer program product for providing a resolution recommendation service, the computer program product comprising computer executable code embodied in one or more non-transitory computer readable media that, when executing on one or more processors, performs the steps of:
receiving at an interface a ticket;
executing at least one of a plurality of processing procedures on the ticket, wherein the processing procedures include a text cleaning procedure, a text normalization procedure, or a text tokenization procedure;
processing the ticket using a pre-trained large language model to extract a context from the ticket, the context including one or more of an element, a relationship, or an intent,
analyzing one or more knowledge base articles using the model and the extracted context to generate a resolution recommendation; and
presenting to a user via a user interface the generated resolution recommendation.

14. The computer program product of claim 13 wherein the ticket is received via at least one of email, a ticketing report, or a user portal.

15. The computer program product of claim 13 further comprising computer executable instructions for performing the steps of:
receiving a user feedback via the user interface regarding the generated resolution recommendation, and
updating the pre-trained large language model based on the received user feedback.

16. The computer program product of claim 13 further comprising computer executable instructions for performing the step of retrieving one or more knowledge base articles from a data store using the extracted context.

17. The computer program product of claim 13 further comprising computer executable instructions for performing the steps of vectorizing a received training ticket to transform the training ticket into at least one vector, and storing the vector in a vector database.

18. The computer program product of claim 13 wherein analyzing the knowledge base articles includes supplying the articles and the extracted context to the model and receiving the resolution recommendation from the model.
